(19) United States
(12) Patent Application Publication
(10) Pub. No.: US 2011/0313889 A1
(43) Pub. Date: Dec. 22, 2011

(54) STREAMING DOWNLOADABLE DISC JOCKEY MIXED MUSIC

(76) Inventor: Jeffrey S. Cohen, Toluca Lake, CA (US)

(21) Appl. No.: 13/080,576

(22) Filed: Apr. 5, 2011

Related U.S. Application Data
(60) Provisional application No. 61/320,971, filed on Apr. 5, 2010.

(51) Int. Cl. G06Q 30/00

(52) U.S. Cl. 705/27.1

(57) ABSTRACT

The present invention includes certain features such as a business method for a professional disc jockey company to sell streaming music that he has professionally “mixed” or “transitioned” over the Internet. This downloadable streaming music disc jockey service acts perfectly for customers that want the sound of a disc jockey, without the expense of a live disc jockey. In practicing the method, the disc jockey company would first determine highly sellable popular genres of music, such as Rock and Roll, Hip Hop, Country, Jazz, and the like. The disc jockey responsible for the project would then run the selection through a “mixing” software to provide a set of music that would sound just like a live disc jockey was playing the music. Once the music is compiled and transitioned, it is uploaded to a computer server where potential customers can make a selection amongst the pre-recorded and pre-mixed music selections, and the customer then may access their desired music mixes by downloading the mixed music on a per-hour-block basis, purchasing, on a subscription basis, where their music is accessed on a computer, phone or other device capable of downloading and accessing, or customers can purchase their music on a monthly basis, depending on the volume of music selections that they have used, but not stored, on their computers. Customers may make their own musical selections and have them transformed into a set that sounds like it has been professionally “mixed”.

### CROSS-REFERENCE TO RELATED APPLICATIONS

This application claims the benefit under 35 U.S.C. 119(e) of U.S. Provisional Application No. 61/320,971 filed on Apr. 5, 2010.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED, INCLUDING ON A COMPACT DISC

Not Applicable

### BACKGROUND OF THE INVENTION

1. Field of the Invention

This invention relates generally to downloadable music, and more particularly relates to a streaming disc jockey service in which the transition between songs is “mixed” professionally.

2. Description of the Prior Art

Online music services and downloadable music services have become extremely popular in American culture these days. In addition, the advent of iPods, iPhones, and other personal recording and communication devices has increased the amount of available music libraries that a person can carry with them for their listening pleasure. Downloadable song services, such as iTunes, commercially available from Apple Inc., of Cupertino, Calif., and the like provide a wide variety of music for people to download so that they may listen to their downloaded music later. Further, there are many other services, for downloading music to make their own playlists for future events.

However, because it is a lot of work and takes time to download all the music, there has been a great deal of interest in streaming online music, including internet radio stations, such as Pandora.com, available over the internet, and other music services of that type. In Pandora.com, you are able to create your own radio station by selecting individual songs and or artists that appeal to you, and then Pandora.com selects similar music and plays it for you thereafter. There are advertisements and pauses between the songs, and there is no transitioning in a smooth manner from one song to the next song.

Conventional disc jockey services have evolved into rather dramatic music presentations for weddings, parties, and the like. Popular disc jockeys become particularly adept at “mixing” or “transitioning” between songs, where the beat of one song is matched up to the beat of another song, so that the people on the dance floor can continually listen to music without an abrupt start-and-stop situation. A good disc jockey will allow people to continue listening or dancing without the song coming to an abrupt end. This transitioning, or mixing, is what separates a good disc jockey from a poor one.

Mixing/transitioning is one of the most desirable advantages that a disc jockey provides over a mere litany of pre-recorded songs. Good disc jockeys make musical selections to make the transitions between songs as smooth as possible. Digital mixing is available from computer software that can digitally mix between a first song and the following song.

These mixing computer software programs are not generally available to the public due to high cost, as well as the fact that the general public would need extensive training to achieve perfection in mixing. As such, it is unlikely that a layman or amateur would be able to produce truly professional “mixed” or “transitioned” mix of music that would be fitting to any type of grand event.

Traditionally, there have been two avenues of delivering music at an event, or for a commercial operation, i.e. recordings made by an individual, or the hiring of a live event disc jockey to do a professional job. With the advent of the Internet, it has become possible to download individual songs, but it has not yet been possible to purchase the services of a truly professional disc jockey that provides professional grade mixing and transitioning between songs over the Internet.

Therefore, it may be desirable for someone planning an event, or for commercial enterprises as well as consumers, where a disc jockey service would be beneficial to purchase either streaming or downloadable professional quality music product.

### SUMMARY OF THE INVENTION

In accordance with the abovementioned desires of individuals in certain industries, including events, restaurants, bars and banquet halls, there is now provided a new streaming disc jockey service which can either be streamed, downloaded, or both in order to provide a professionally transitioned music service. The present invention discloses a novel business model, process and a new musical product, for streaming disc jockey type music with a professional grade presentation of the music that includes a “mixing” or “transitioning” service to be provided by a centrally licensed music seller. This new business model may preferably be a subscription based service, in order to pay for the songs as well as the professional services of a disc jockey performing the transitioning and mixing of the purchased music, or it may be a downloadable service that is paid for on a “per event” basis.

In a first aspect of the invention, once a genre of music is selected as a potentially marketable set, the streaming disc jockey service business will purchase and download an appropriate number of potentially desirable songs, and then their disc jockey employees will mix and edit the pre-selected playlist of songs through the use of mixing software at their headquarters, in the hopes that customers will want to buy their selections. Once the music is compiled and transitioned, it is uploaded to a computer server where potential customers can make a selection amongst the pre-recorded and pre-mixed music selections, and the customer then may access their desired music mixes by any of the following methods:

1.) downloading the mixed music on a per-hour-block basis,

2.) purchasing, on a subscription basis, where their music is accessed on a computer, phone or other device capable of downloading and accessing, or

3.) customers can purchase their music on a monthly basis, depending on the volume of music selections that they have used, but not stored, on their computers.

In accordance with the above-noted desires of the industry, the present invention provides various aspects, including a streaming downloadable mixed music service that has been professionally prepared, a method of making same, and a method of using the music provided by the disc jockey service, and a business method for selling the same. This overcomes all of the aforementioned problems with the prior art because a new service is born that satisfies the need for an internet presentation of professional disc jockey music.

This technique of downloading streaming disc jockey services and products may therefore be extended to include not only the streaming of mixed or transitioned music, but also provides a new method of servicing a need for an inexpensive disc jockey service for customers that do not need to utilize the services of a live disc jockey. The invention is particularly useful for applications of weddings, parties, mitzvahs, and other social events that desire a professional music service.

### BRIEF DESCRIPTION OF THE DRAWINGS

For a further understanding of the nature and advantages of the expected scope and various embodiments of the present invention, reference shall be made to the following detailed description, and when taken in conjunction with the accompanying diagrams and drawings, in which like parts are given the same reference numerals, and wherein:

FIG. 1 is a diagrammatic view of a flowchart showing the steps in the business method for selling pre-mixed professional disc jockey music made in accordance with the present invention;

FIGS. 2-9 illustrate the computer screen details for the selection and operating processes.

Although the invention will be described by way of examples hereinbelow for specific embodiments having certain features, it must also be realized that minor modifications that do not require undo experimentation on the part of the practitioner are covered within the scope and breadth of this invention. Additional advantages and other novel features of the present invention will be set forth in the description that follows and in particular will be apparent to those skilled in the art upon examination or may be learned within the practice of the invention. Therefore, the invention is capable of many other different embodiments and its details are capable of modifications of various aspects which will be obvious to those of ordinary skill in the art all without departing from the spirit of the present invention. Accordingly, the rest of the description will be regarded as illustrative rather than restrictive.

### DETAILED DESCRIPTION OF THE INVENTION

A first aspect of the present invention includes certain features such as a business method for a professional disc jockey to sell streaming music that has been over the Internet that has been professionally mixed or transitioned by a professional disc jockey over the Internet. First, the disc jockey company would determine popular genres of music, such as Rock and Roll, Hip Hop, Country, Jazz, and the like. After selecting a number of songs in that genre, the disc jockey company would purchase those songs, along with the right to re-sell the songs to further customers.

Then, the disc jockey company would apply the selection of songs to at least one computer software program to effect a seamless transition between the songs, so that the grouping of songs are “transitioned” to sound like a set of songs that have been professionally transitioned by a commercial disc jockey. Once the music has been processed to sound right, the package of songs is created to sell.

Once the disc jockey company offers this created product, on any suitable subscription basis, customers can purchase and/or listen to their desired music on a periodic basis, depending on the volume of music selections that they have stored, on their computers.

The method of purchasing streaming music that has been professionally mixed or transitioned by a professional disc jockey may include downloading streaming music off the Internet that has been previously professionally pre-mixed at a remote location, and paying for the download by utilizing any suitable method of payment, wherein said purchase may be accomplished by selection on a basis consisting of a per-hour-block basis; a periodic basis such as monthly or weekly; a one time purchase basis; and a subscription basis. The purchase may be made on a subscription basis, where the streaming mixed music is accessed on a computer, phone or other device capable of downloading and accessing. Otherwise, the customers can purchase their music on a periodic basis, depending on the volume of music selections that they have used, but not stored, on their computers.

The music may be first purchased and compiled in musical categories or genres, thereby allowing customers to choose between various musical categories that suit their taste and/or their event. Then, the music may be put through the mixing or transitioning software owned by the business owner, to compile a streaming collection of songs that have been appropriately “mixed” or “transitioned”. Then, the finished product is placed into selectable musical categories, and the customer can buy the mixed music in a variety of ways, described hereinabove.

In this regard, an order may be placed by a subscriber that desires a musical product which is already pre-selected, mixed and then delivered to that subscriber in a streaming fashion, without the subscriber having to do any work. In my new business model, the disc jockey selects the desired appropriate music, and then either transitions it by using turntables, or by utilizing mixing software, such as the following possibilities: 1.) Mixmaster, commercially available from MixMeister Technology LLC, of Fort Lauderdale, Fla.; 2.) Ableton Live, commercially available from Ableton, Inc., of Germany; 3.) Pro Tools, commercially available from Avid Technology, Inc., of Tewksbury, Mass.; 4.) Wave Lab, commercially available from Steinberg Media Technologies of Germany; or 5.) Scratch Live commercially available from Serato Corporation of New Zealand. Of course, any suitable mixing software is acceptable for the present invention. Once the playlist has been selected and the music has been transitioned, then the disc jockey saves it into memory and sells it, i.e. to a subscriber in a streaming music service.

There are several ways for the disc jockey who has received a work order from a subscriber to pick his playlist, i.e. by genre, music type, year of release, artist, or any other number of means for categorizing music into a pleasing selection for the subscriber. The subscriber may select the category that he desires. Once the playlist has been selected, the disc jockey is to perform his service of making the music transition from one song to another without abrupt starting or stopping. This makes for a more pleasing streaming music experience, and it also means that the music never stops.

In order to transition the music, a traditional disc jockey has provided “mixing” services by utilizing several turntables and blending the two musical selections together, whether in real time, or by utilizing electronic mixing software, as described more fully hereinabove. In addition, there is MIDI software, commercially available from MIDI Manufacturers Association, of Los Angeles, Calif. MIDI software can accentuate certain beats of music, as well as can enhance vocals and lead to provide a smoother transition between songs. The mixing software and/or the MIDI software can be used singly, together, sequentially, or any combination thereof.

Recently, mixing software has been available to the commercial music industry, such that a digital soundtrack can be transitioned and merged into a next selection, where the beats of the music and the instrumentation may be blended to provide a seamless transition from one song to the next.

Once the playlist has been selected and the music has been transitioned or mixed or conditioned in any way that is desired by the subscriber, the music can be saved in a digital format, and then transmitted to a subscriber, after the subscriber has paid for the service. The subscriber can order one hour of music, five hours of music, or a particular system of song play-listing that he desires. In this business method patent application, a subscriber may order a particular litany of music selections to yield a playlist that does not fall into a single category, but rather is a mere sequential playing of music that a subscriber desires, but where each song is transitioned into the next.

In further aspects of the present invention, conventional disc jockey wisdom prescribes that the designed mix stream should contain about five (5) hours of music to create a normal music set of five hour blocks of music, selected edited and transitioned track to track. A five hour block of music is most marketable for social events and weddings. Each block of music will preferably have a ID tag assigned in the inventory, so that when accessed by different customers or users, each of them receives a different block or random chosen block within that musical category.

The various aspects attributed to the different players that can be utilized may also have additional buttons added on the bottom real estate of each device in order to include “on demand” drops such as ads, sound effects, and/or microphones for the social event coordinator to be able to make announcements or to voice over certain parts of the music being played.

In yet a further aspect of the present invention, advertising features may be incorporated into the stream block. In this aspect, the advertising feature may assign the current stream to automatically lower in volume while the advertising segment plays over the mix. Thereafter, the normal volume will resume. Under certain circumstances, the advertising feature could also have a looping button next to the ad feature button, if the customer chooses to have the drops automatically play at a preset time.

This new business method service may be particularly desirable to busy people who do not have time to download all of the music that they would like. This is especially useful where a nicely orchestrated transitional mix of their favorite tunes would be something they would like to download onto their iPod or iPhone for listening at a later time. Of course, restaurant and liquor establishments may find particular utility with the present invention in order to play the music at the establishment for their customers. In addition, doctor's offices, clothing store and retail store music playing would be desirable. Since a business establishment cannot merely play a radio station without copyright infringement, paying for their music is a nice alternative for them to provide pleasing a atmosphere for their customers. Clothing stores can provide very peppy music in order to urge shoppers to buy more than they normally would, because they have a lot of feel good music being played in the background, urging shoppers to spend more money.

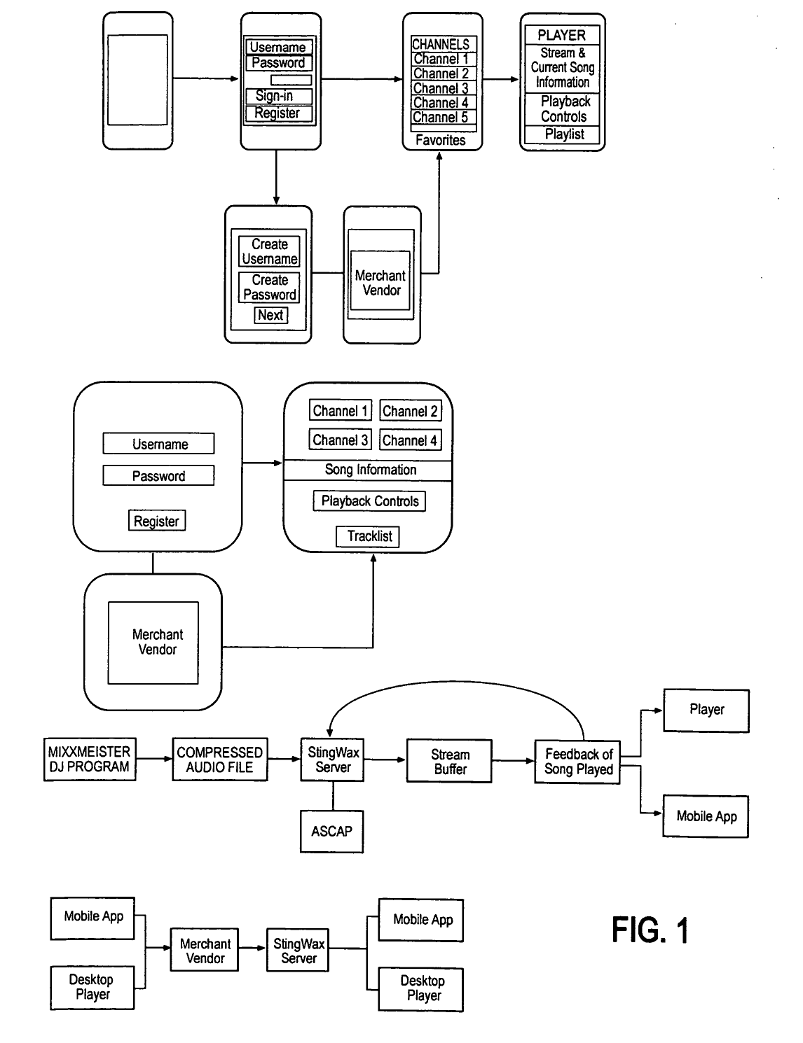

Referring now to the drawings in detail, FIG. 1 is a diagrammatic view of a flowchart generally indicated for a mobile app, a desktop player, and a backend music playback. The mobile app shows how the customer would select their music, review the channels, and pay for the service. The desktop player is equally as simple, where a customer first enters his username, password and click on “Register”. Then the “Merchant Vendor” screen emerges for payment, and the customer selects which channel they want to hear, and control screens become possible. Menus are selectable on the screen for Playback Controls and Tracklisting. For Playback situations, where the music is being purchased, the purchasing steps incorporate the company's server connected to the payment program.

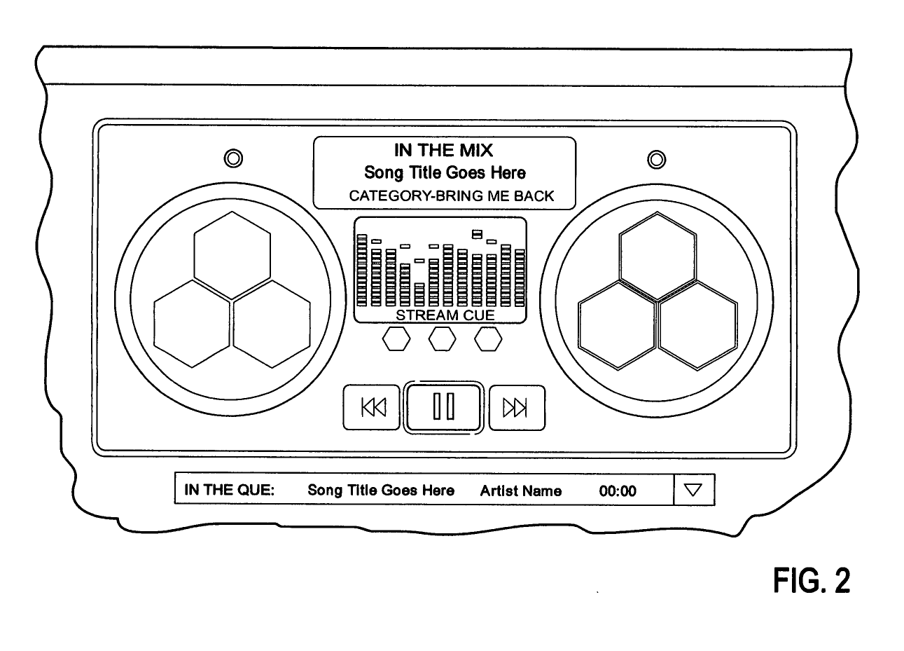

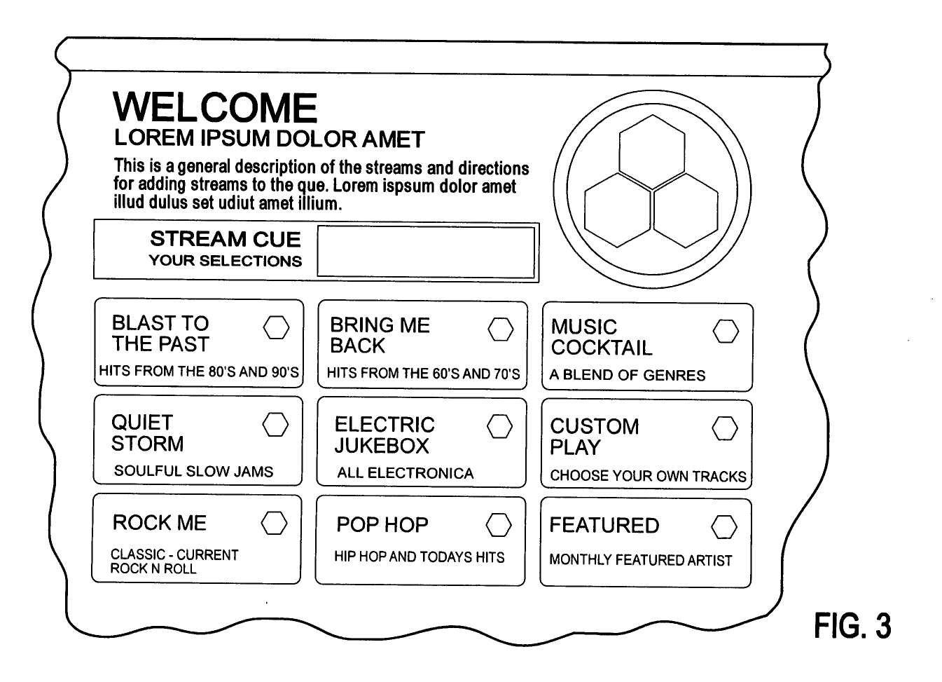

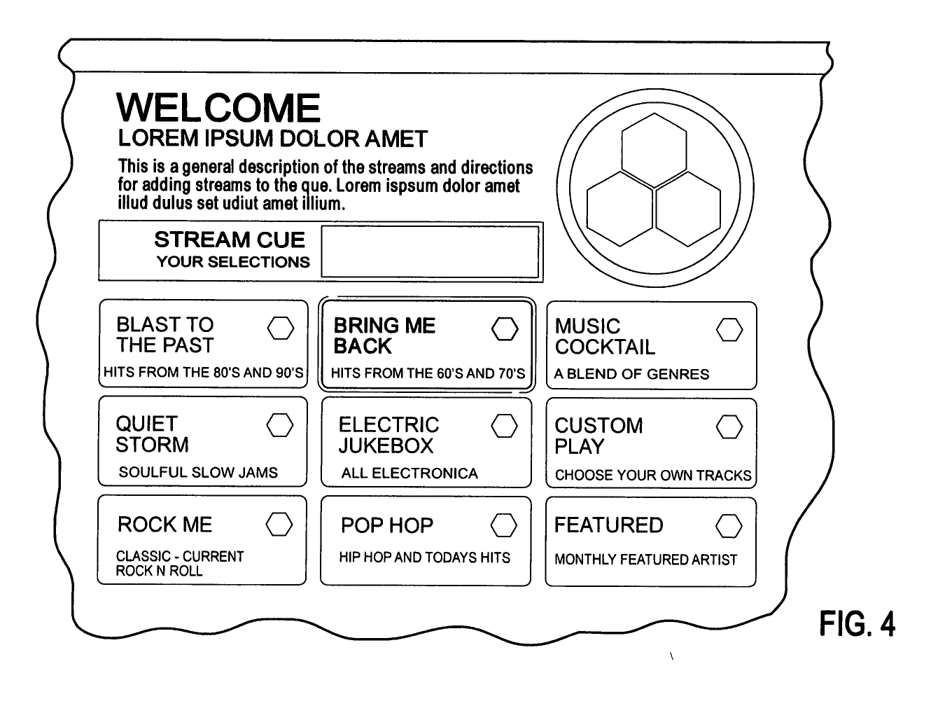

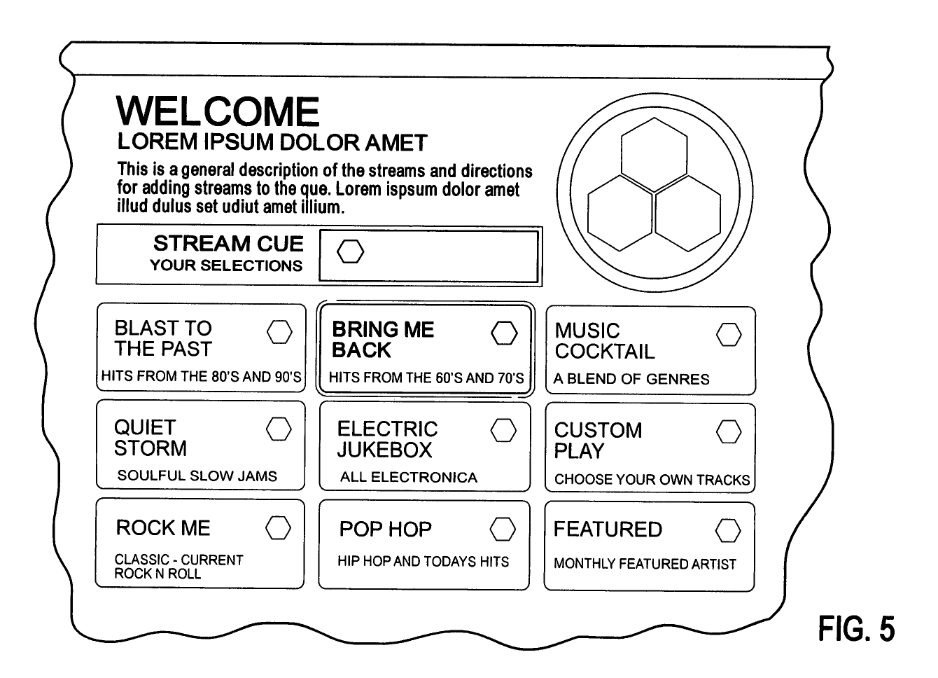

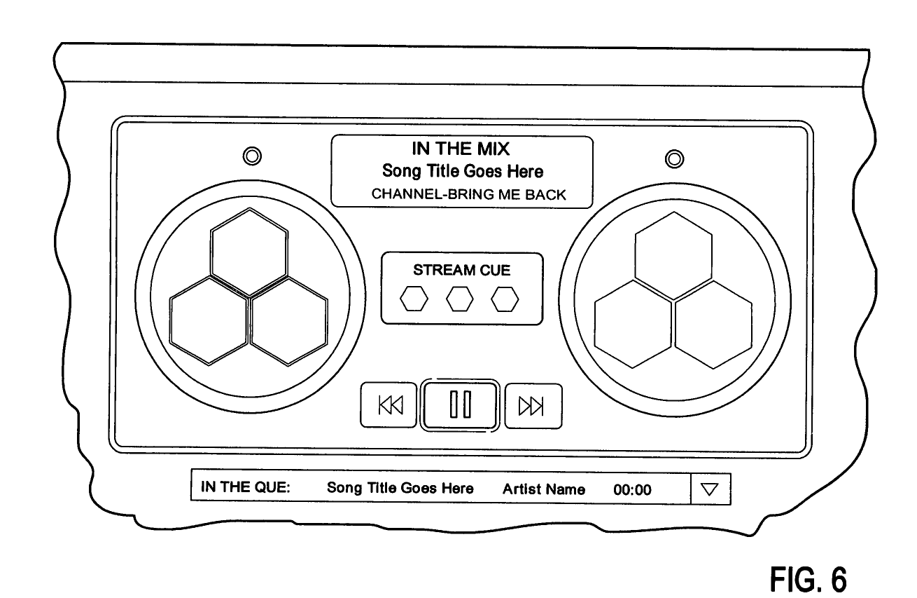

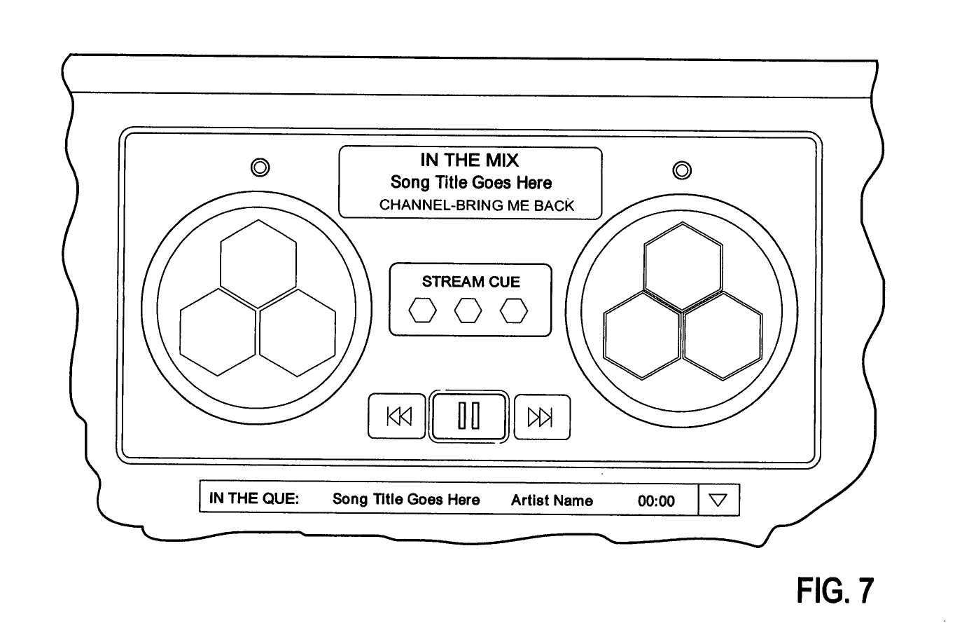

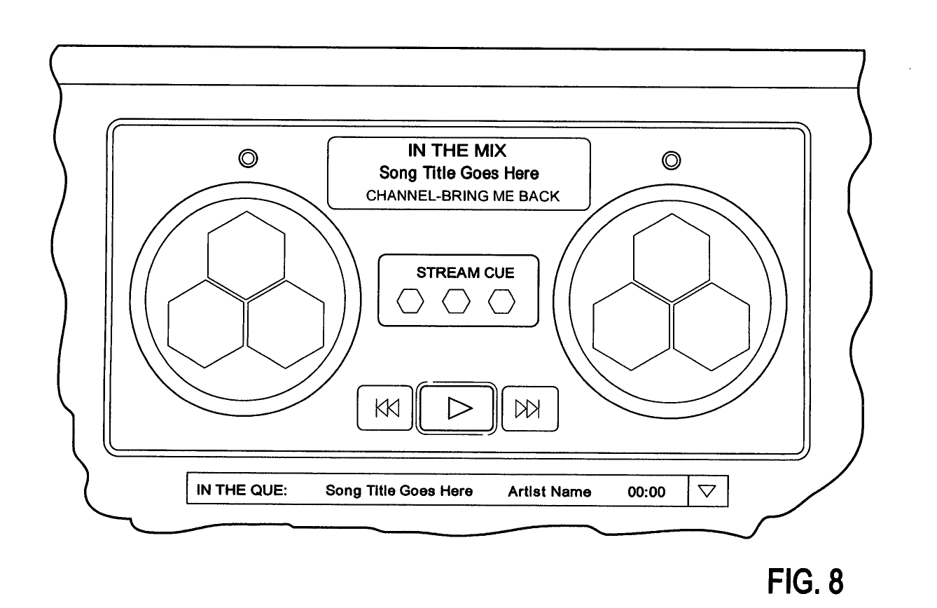

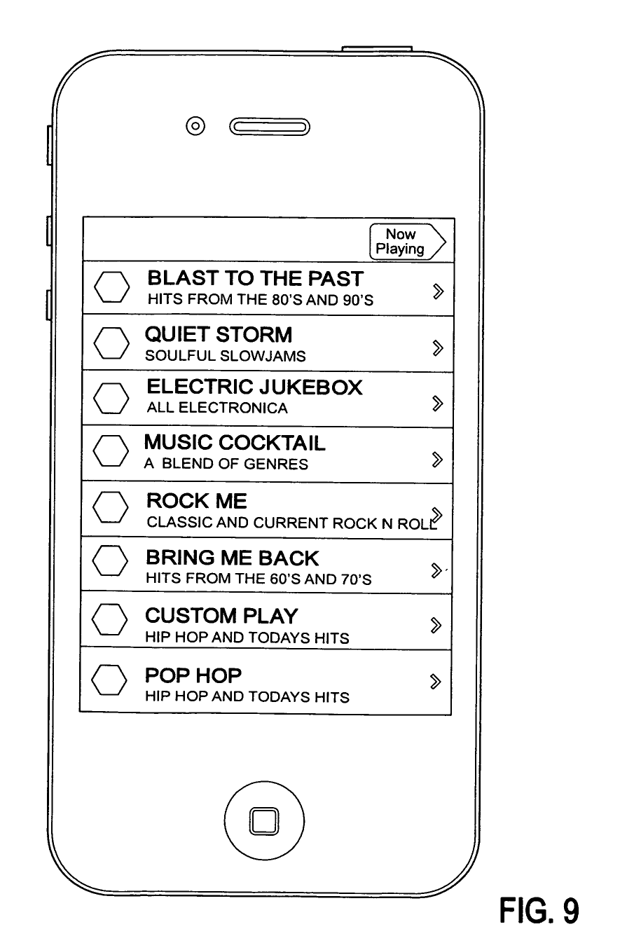

In a collective review of FIGS. 2-9, there are shown screenshots of the mixing computer, where FIG. 2 shows a first song being played on the left, while the song on the right is not yet playing. This virtual Digital DJ Center mixing board shown will activate the mixing function when the first song comes to the end. The second song will begin to play after the mixing function blends the two songs. FIG. 3 shows a potential screenshot of a selection screenshot for various genres of music that can be selected. FIG. 4 shows the darkened button indicating the “Bring Me Back” genre has been selected while FIG. 5 illustrates a screenshot when the stream cue is activated. FIG. 6 indicates a mixing function in the first step, while FIG. 7 shows the second song beginning to play, after mixing. FIG. 8 illustrates the relative placement of the various buttons for functionality, while FIG. 9 shows a possible screenshot for a Smartphone app.

In summary, numerous benefits have been described which result from employing any or all of the concepts and the features of the various specific embodiments of the present invention, or those that are within the scope of the invention. The downloadable streaming music disc jockey service acts perfectly for customers that want the sound of a disc jockey, without the expense of a live disc jockey.

The foregoing description of a preferred embodiment of the invention has been presented for purposes of illustration and description. It is not intended to be exhaustive or to limit the invention to the precise form disclosed. Obvious modifications or variations are possible in light of the above teachings with regards to the specific embodiments. The embodiment was chosen and described in order to best illustrate the principles of the invention and its practical applications to thereby enable one of ordinary skill in the art to best utilize the invention in various embodiments and with various modifications as are suited to the particular use contemplated. It is intended that the scope of the invention be defined by the claims which are appended hereto. The various aspects of the invention were chosen and described in order to best illustrate the principles of the invention and its practical applications to thereby enable one of ordinary skill in the art to best utilize the invention in various embodiments and with various modifications as are suited to the particular use contemplated.

What is claimed is:

1. A method of purchasing streaming music that has been professionally mixed or transitioned by a professional disc jockey, comprising:
downloading streaming music off the Internet that has been previously professionally pre-mixed at a remote location;
paying for the download utilizing a method of payment, wherein said purchase may be accomplished by selection on a basis consisting of a per-hour-block basis; a periodic basis such as monthly or weekly; a one time purchase basis; and a subscription basis.

2. A method of purchasing streaming music that has been professionally mixed or transitioned by a professional disc jockey, comprising:
downloading streaming music off the Internet that has been previously professionally pre-mixed at a remote location;
purchasing, on a subscription basis, where the streaming mixed music is accessed on a computer, phone or other device capable of downloading and accessing.

3. (canceled)

4. A business method of selling streaming music over the Internet that has been professionally mixed or transitioned by a professional disc jockey, comprising:
selecting a number of songs;
purchasing those songs with the right to re-sell the songs to further customers;
applying the selection of songs to at least one computer software program to effect a seamless transition between said songs, wherein a grouping of songs are “transitioned” to sound like a set of songs that have been professionally transitioned by a commercial disc jockey;
creating a simulated set of transitioned songs to sell;
downloading streaming music onto the Internet that has been previously pre-mixed;
offering, on any suitable subscription basis, where customers can purchase or listen to their desired music on a periodic basis, depending on the volume of music selections that they have stored, on their computers.
